(19) United States
(12) Patent Application Publication
(10) Pub. No.: US 2003/0012833 A1
(43) Pub. Date: Jan. 16, 2003

(54) Screening arrangement

(76) Inventors: Manfred Franz Axel Freissle, Johannesburg (ZA); Jacobus Janse Van Rensburg, Johannesburg (ZA)

Correspondence Address: FROMMER LAWRENCE & HAUG, 745 FIFTH AVENUE- 10TH FL., NEW YORK, NY, 10151, US

(21) Appl. No.: 10/175,468

(22) Filed: Jun. 19, 2002

(30) Foreign Application Priority Data
Jun. 27, 2001 (ZA) 2001/5310

(51) Int. Cl. B22F 3/08; B07B 1/00; B03B 1/00

(52) U.S. Cl. 425/1; 209/1

(57) ABSTRACT

A screening element 10 for screening particulate materials such as mineral ores of all types, shapes are a densities, as well as difficult to screen cloggy, and slabby materials. The screening element 10 has a screening surface 12 formed by a plurality of elongate zig-zagged shaped ribs 14. The ribs 14 are resiliently deformable and extend within the periphery of the element 10 in a chevron pattern across the element 10. The ribs 14 are spaced from each other to define between them rows of square screening apertures 22. The screening apertures 22 have sides 22.1 which are orlentated transversely at 90° to an axis 10.1 of the screening element 10; and sides 22.2 which are substantially aligned with the axis 10.1. The element 10 is divided into two rectangularly shaped portions 16, 18 by a centrally disposed straight rib 20. The ribs 14 extend, in the portion 16, at an angle A of approximately 315° to the axis 10.1; and in the portion 18, at an angle B of approximately 45° to the axis 10.1.

### BACKGROUND OF THE INVENTION

THIS INVENTION relates to a screening arrangement. The invention relates in particular to a screening arrangement for screening particulate materials such as mineral ores of all types and shapes and densities, as well as difficult to screen cloggy and slabby materials. More particularly, the invention relates to screening elements and to screen decks.

The Applicant is aware of screen decks which are of stretchable mats or of a modular configuration comprising a plurality of panels which are releasably secured in a side-by-side relationship on a support frame. When certain types of ore are screened, it sometimes happens that the apertures In the screen deck become blocked and the deck and the screen deck, or portions of the screen deck, then become blinded or clogged. This leads to screening inefficiency.

The Applicant is further aware of its own screening arrangement and screening elements as described and claimed in South African patent no. 88/8946 and its corresponding foreign patents. These screening elements are predominantly of a synthetic plastics material and have a screening surface formed by a plurality of ribs extending within the surround across the element, the ribs each being of a zig-zag configuration and being spaced from each other to define between them screening apertures, the ribs being resiliently deformable. The ribs are so positioned and spaced from each other that rows of apertures spaced from each other are defined between the ribs. In use, when screening elements of this kind are located in position in a screening arrangement, the ribs are orientated generally axially along the screening arrangement. Since the ribs are of zig-zag configuration, this results in screening apertures having sides which whilst being orientated at an angle of approximately 45° to the axis of the screening element, are not substantially transverse thereto.

Material to be screened generally flows axially along the screening arrangement and is thus funnelled by these sides of the screening apertures and into the screening apertures, thereby assisting in forcing the material to drop into the apertures.

A disadvantage of this type of screening element is that, whilst the sides of the screening apertures funnel the material to be screened, their efficacy in screening the material is reduced by their orientation at an angle of approximately 45° to the axis of the screening element.

It is an object of the invention to provide a screening arrangement which overcomes or alleviates the above-mentioned problem.

### BRIEF DESCRIPTION OF THE INVENTION

According to one aspect of the invention there is provided a screening element which has a screening surface formed by a plurality of elongate ribs extending within the periphery across the element the ribs either alternately changing direction or varying in width along their length and being resiliently deformable, the ribs being orientated and spaced from each other to define between them rows of screening apertures, such that the screening apertures have at least some sides which are orientated substantially transversely to the axis of the screening elements.

Said sides of the screening apertures may be orientated at an angle of from 65° to 125°, or from 245° to 305°, to the axis of the screening element.

The ribs may alternately change direction by being of zig-zag configuration.

The zig-zag configuration of the ribs may be angular so that substantially rectangular-shaped apertures are defined between the ribs, with opposed sides of the apertures being formed by edges of the ribs.

A pair of opposed sides of each screening aperture may be disposed substantially transversely to the axis of the screening element.

Preferably, the apertures are square.

The ribs may extend across the screening surface at an angle of from 10° to 80° or from 280° to 350° to the axis of the screening element.

Opposed portions of adjacent ribs may be alternately spaced at different distances from each other, to thereby define between them the screening apertures.

The screening element may include a centrally disposed, straight rib extending between axially opposed sides of the element; laterally opposed sides of the element interconnected and held in laterally spaced relationship by the axially opposed sides of the element, such that the element is divided into two rectangularly shaped portions, the ribs extending in a chevron-like fashion within the periphery of the element, one half of the chevron extending across each said portion and ending in the straight rib.

In this case, the ribs forming one half of the chevron may extend across the screening surface at an angle of from 10° to 80°, and the ribs forming the other half of the chevron may extend across the screening surface at an angle of from 280° to 350°, to the axis of the screening element.

The axially opposed sides of the element and the laterally opposed sides of the element may form the periphery of the element, with the apertures on each row of screening apertures adjacent the periphery of the screening element being open on one side, and apertures in each row Inwardly of these apertures being open on two sides. Bridging ribs may interconnect adjacent zig-zag ribs at predetermined locations, in which case the apertures on opposed sides of the bridging ribs will be open on one side.

The screening element may be a panel having securing means adapted to secure the panel releasably in a side-by-side relationship with similar panels on a screen deck, the screening surface being located within the periphery of the panel, and the ribs extending within the periphery across the panel as described above.

The panel and the ribs and the securing means may be of the same material and may be unitary and in one piece.

The securing means on the screening panel may comprise a plurality of deformable spigot-like protrusions spaced from each other along the periphery of the panel.

The protrusions may be adapted to fit in pairs with the protrusions of an adjacent similar panel In complementary spaced apertures in a support structure of a screen deck.

The protrusions may be half-tubular so that when such protrusions are fitted in pairs in the apertures of the support structure, the protrusions form tubular bores into which securing pins may be fitted to spread the protrusions to engage the support structure.

Instead, the protrusions may be solid.

The screening panel may be reinforced, e.g. by steel reinforcing bars embedded in the element, in particular in the laterally opposed and axially opposed sides of the panel, and in the straight rib.

Each rib may taper in the direction of the flow of material through the screening surface to thereby define screening apertures which diverge in the direction of flow of material through the apertures.

The screening element may be moulded, e.g by injection moulding, or pressure moulding, of synthetic plastics material which may be polyurethane or rubber.

The invention extends to a screen deck including a support structure and one or more screening elements in accordance with the invention, arranged on the support structure.

### DESCRIPTION OF THE DRAWINGS

The invention is now described with reference to the accompanying drawings, in which

FIG. 1 shows a plan view of a screening element in accordance with the invention;

FIG. 2 shows a side view of the screening element of FIG. 1;

FIG. 3 shows a fragmentary plan view of a screen deck comprising one screening element as in FIG. 1, in position on a support frame;

FIG. 4 shows a fragmentary plan view of a screen deck similar to that shown in FIG. 3, but with three screening elements of FIG. 1, in position on a support frame;

FIG. 5 shows a side view of the screen deck shown in FIG. 4;

FIG. 6 shows, on an enlarged scale, a fragmentary section along line VI-VI in FIG. 4;

FIG. 7 shows an underplan view of the screening element of FIG. 1;

FIG. 8 shows a plan view of another screening element in accordance with the invention.

### DETAILED DESCRIPTION OF THE DRAWINGS

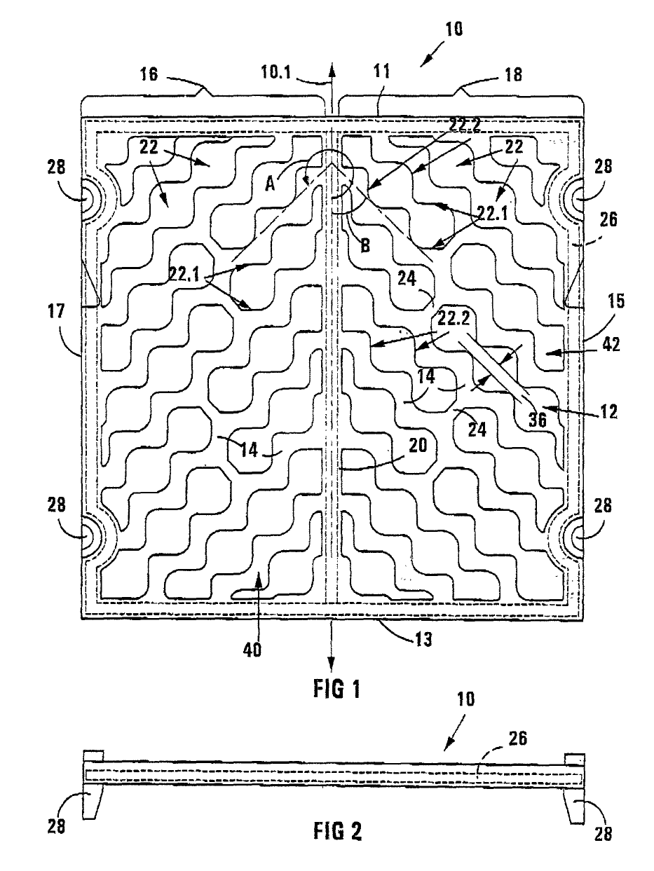

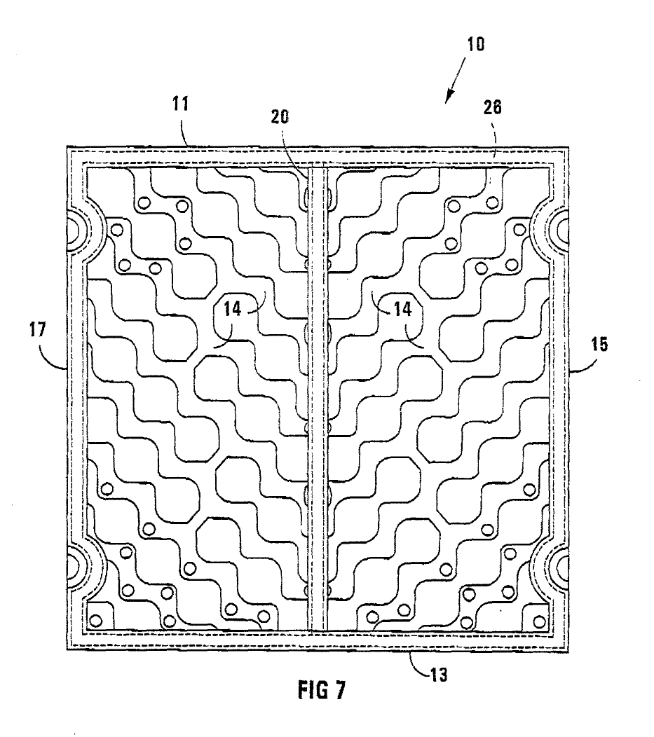

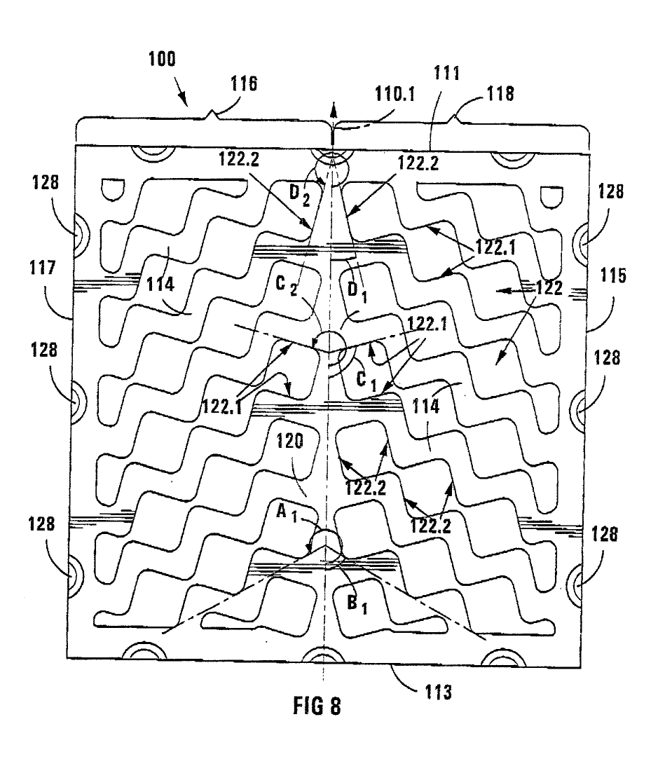

Referring to FIGS. 1, 2 and 7 of the drawings, reference numeral 10 indicates in general a screening element in the form of a panel which is of a hard-wearing synthetic plastics material, e.g. polyurethane or rubber, having a Shore hardness of 40-90, depending on the type of particulate material to be screened. The panel has a screening surface 12 formed by a plurality of zig-zag-shaped ribs 14. The panel 10 has axially opposed sides 11 and 13 and laterally opposed sides 15 and 17 which are interconnected by the axially opposed sides 11, 13, the sides 11, 13, 15 and 17 forming the periphery of the panel 10. The panel 10 is divided into two rectangularly shaped portions 16 and 18 by a centrally disposed, straight rib 20 extending between the axially opposed sides 11 and 13 of the panel 10. The panel 10 has an axis 10.1.

The zig-zag-shaped ribs 14 are resiliently deformable and extend in a chevron pattern across the screening surface 12 within the periphery of the panel 10, one half of the chevron extending across each portion 16, 18 and ending in the straight rib 20. The ribs 14 extend, in the portion 16, at an angle A of approximately 315° to the axis 10.1; and in the portion 18, at an angle of approximately 45° to the axis 10.1. The Applicant believes that this orientation of the ribs 14 allows for their point of attachment 14.2 to the sides of the panel 10 to be wider and the connection of the ribs 14 to the periphery of the panel stronger, and less vulnerable to wear in use, leading to an increase in the useful life of the panel 10 of the invention. The ribs 14 are of the same synthetic plastics material as the sides 11, 13, 15 and 17, and are unitary with the sides. The ribs 14 are spaced from each other and their zig-zag configuration is such that they define between them square apertures 22. The screening apertures 22 have sides 22.1 which are orientated transversely at 90°, to the axis 10.1 of the screening panel 10; and sides 22.2 which are substantially aligned with the axis 10.1 of the panel.

The apertures 22 are open-ended along one or two sides, depending on whether they are adjacent the periphery of the panel 10, are adjacent one another but divided by bridging pieces 24, or are intermediate and inwardly from the periphery of the panel 10 or end in the centrally disposed straight rib 20. The zig-zag ribs 14 are flexible and are resiliently deformable and are more flexible than the sides 11, 13, 15 and 17 of the panel 10, and also more flexible than the centrally disposed straight rib 20. The bridging pieces 24 have the effect of stabilizing the apertures 22 and providing a relatively consistent aperture configuration across the screening surface 12.

The screening panel 10 is reinforced by means of steel reinforcing bars 26 which are embedded within the sides 11, 13, 15, 17 and the straight rib 20 of the panel 10.

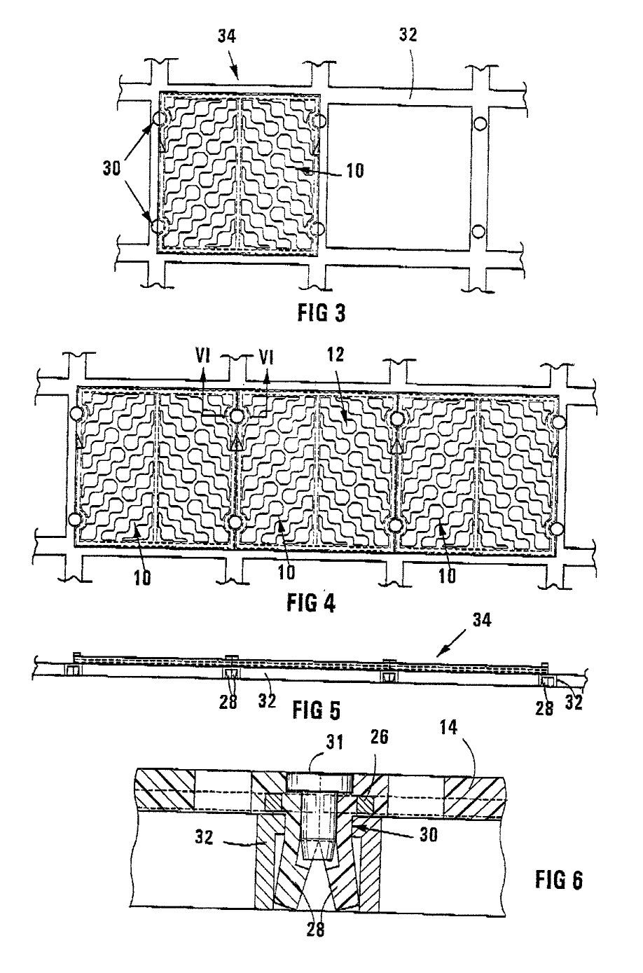

Referring further to FIGS. 1 and 2, the screening panel 10 has a plurality of protrusions 28 provided along the entire periphery of panel 10 as shown, or alternatively the protrusions 28 may be provided along only part of the periphery of the panel 10. The protrusions 28 are spigot-like of tapering configurations, and are half tubular so that when such protrusions are fitted in pairs in apertures 30 of a support frame 32 as shown in FIGS. 3 to 6 of the drawings, the protrusions 28 form tubular bores 29 into which securing pins 31 may be fitted to spread the protrusions to engage the support frame 32. Thus, the protrusions 28 are of the same material as the panel 10, and are integral with the panel and are resiliently deformable to permit the pins 31 to spread them and, also when the pins are removed to allow the protrusions to return to their original position so as to permit the panels 10 to be removed from the apertures 30 in the support frame 32, as shown in FIG. 6.

Referring to FIG. 3, there is shown a screen deck 34 comprising a support frame 32, with a screening panel 10 of FIG. 1 positioned thereon. The support frame 32 is a lattice-work of steel sections of L- or U-cross-section. A plurality of apertures 30 are provided in the support frame 32, the spacing between the apertures 30 corresponding to the spacing of the protrusions 28 of the panel 10 from each other, the protrusions 28 being shown in FIG. 2. The panel 10 is fitted onto the support frame 34 by Inserting the protrusions 28 into the apertures 30 and then forcing pins 31, e.g. by hammering, them into the bore 29 formed by mating protrusions, such that the protrusions 28 spread and fix the panels 10 onto the support frame 32.

FIGS. 4 and 5 show a screen deck 34 similar to that shown in FIG. 3, except that three screening panels 10 are fitted adjacent each other in a side-by-side abutting relationship on the support frame 34. The protrusions 28 on adjacent screening panels 10 are fitted in pairs into the apertures 30 of the support frame 32 as shown in FIG. 6. As shown, the protrusions 28 are spread by means of the pins 31 when the panels are fitted onto the screen deck 34, and can be retracted by removing the pins 31 when all panels 10 are to be removed from the deck 34.

The entire screening panel 10, including the sides 11, 13, 15 and 17, the ribs 14 and the straight rib 20 and the protrusions 28 are formed in one piece by means of injection moulding from a suitable rubber.

Referring to FIG. 8 of the drawings, a further panel, generally designated by reference numeral 100, according to the invention, is shown. The same or similar features referred to in FIGS. 1 to 7 are denoted by the same reference numerals increased by 100. The ribs 114 extend, in the portion 116, at an angle A₁ of approximately 305° to the axis 110.1 of the panel 110; and in the portion 118, at an angle B₁ of approximately 55° to the axis 110.1. In the portion 118 of the panel 100, the sides 122.1 of the screening apertures 122 are orientated at an angle C₁, of approximately 105° to the axis 110.1 of the panel, and are thus substantially transverse to the axis 110.1 of the panel 100; and the sides 122.2 of the apertures are orientated at an angle D₁ of approximately 15° to the axis 110.1 of the panel, and are thus substantially in alignment with the axis 110.1 of the panel 100. Similarly, in the portion 116 of the panel 100, the sides 122.1 of the apertures are orientated at an angle C₂, of approximately 255° to the axis 100.1 of the panel; and the sides 122.2 of the apertures are orientated at an angle D₂ of approximately 345° to the axis 100.1 of the panel 100. The panel 100 does not have bridging portions 24 as does the panel 10 of FIGS. 1 to 7, interconnecting the ribs 114. This renders the ribs 114 of the panel 100 relatively more flexible than in the case of the panel 10 of FIGS. 1 to 7, thereby enhancing the screening and de-blinding capabilities of the panel 100.

The Applicant also believes that the invention allows for various combinations of the angle of orientation of the ribs 14, and the angle of orientation of the sides 22.1 and 22.2 of the apertures 22, relative to the axis 10.1 of the panel 10. Thus, the configuration of the ribs and apertures and the resulting chevron pattern across the panel can be chosen, within the parameters set out above, to accommodate various different types of ores which are difficult to screen and/or which have a tendency to clog up a screen. This in turn allows for the maximisation in screening efficiency of a panel for a particular type of material to be screened.

Referring further to FIG. 1, it will be noticed that the zig-zag ribs 14, at their closest, are spaced a distance 36 from each other. This ensures that the ribs 14, when the panel is not in use, do not abut each other, This permits the ribs 14 to vibrate independently of each other when the panels 10 are vibrated on the support frame 32 during a screening operation. It further permits the ribs 14 to be deformed in a lateral direction so that thereby the apertures 22, defined between them can be enlarged. The effect of these features is that when the material is screened and the material becomes stuck in the apertures 22 between the ribs 14, the ribs can flex independently of each other during the vibration to which the panels on the screen deck are subjected during the screening operation, and thereby the material blocking the apertures 22 can be dislodged and pass through the screen.

This allows for screening of particles to within an acceptable range of sizes for a longer period, depending on the coarseness of the particles desired. The screening panels of the invention are particularly effective also, and a substantial improvement over the known panels, in cases where the material to be screened includes unwanted angular or slab shaped particles, eg in the case of iron ore or coal. These angular or slab shaped particles tend to become lodged in the spaces 36 between adjacent ribs 14, thereby blocking the screening surface and deflecting following particles moving across the screen. The capability of the ribs 14 to flex independently of each other as a result of the vibration to which the panels are subjected during screening, causes these particles to become dislodged and pass over the screen. In this manner, the blinding of the screening panels 10 is avoided, or blinding is alleviated.

In addition, a further advantage of the panel 10 in accordance with the invention is that the screening apertures 22 have sides 22.1 which are either substantially transversely disposed to the axis 10.1 of the panel 10, or are substantially aligned with the axis 10.1. Thus, material to be screened which may be flowing in the direction of arrow 40 axially along the panel 10 will encounter the transversely disposed sides 22.1 and be forced to drop Into the apertures 22, thereby providing more accurate and effective screening of the material as well as reduced incidence of blinding, than with other screening panels known to the applicant. Similarly, where matter to be screened flows across the panel In the direction of arrow 42, it will encounter sides 22.2 which are substantially aligned with the axis of the panel and thus disposed substantially transversely to the direction of flow 42 of the particulate material, and the effect on the screening will be the same as described above in relation to matter which flows axially along the panel in the direction of arrow 40. Simultaneously, and as described above, there is a reduced tendency of the panels towards clogging or blinding.

Also, the orientation of some of the sides 22.1 of the apertures 22 substantially transversely to the axis 10.1, as opposed to being at 45° to the axis as is the case with the screening panel of the applicant's South African patent no. 88/8946, means that the funnelling effect of the latter panel is reduced, if not eliminated, in the panel of the present invention. The Applicant believes that this in turn reduces the incidence of slabby material becoming lodged in the spaces 36 between the ribs 14, which reduces the degradation of the screened material.

A yet further advantage of a screening panel according to the invention is that, by virtue of the ribs 14 extending across the screening surface at the angles referred to above, the ribs are longer than they would have been had they extended at 90° to the axis 10.1 across the panel. Thereby the ribs are rendered relatively more flexible and their screening and de-blinding capabilities enhanced. A further effect and advantage of the zig-zag shaped ribs 14, is that the apertures defined between them are mostly continuous in that the one aperture runs into the adjacent one, except where apertures are divided by the bridging pieces 24. The overall effect of this is that a larger open or apertured area is provided in the screening surfaces of the screening panels 10, and this further assists in the screening efficiency of the screening panels in accordance with the invention. These advantages apply to a screening panel of the invention having ribs 14 of different configurations as shown in FIGS. 9 to 14 of the drawings, and in which the distances between opposed portions of adjacent ribs is substantially constant, thus forming a slotted screening surface.

A further advantage of the panel 10 having the rib and aperture configuration shown in FIGS. 1 and 8 of the drawings is that, whilst the ribs 14 are thereby rendered more flexible and their de-blinding capabilities enhanced, the sides 22.1, 22.2 of the apertures remain substantially transverse to, or in alignment with, the axis of the panel 10.1 respectively. This in turn presents ridges across the flow material over the panel, as described with reference to FIG. 1 below, which maintains the screening efficiency of the panel. As opposed to this, the known panel described in the Applicants South African Patent No. 88/8946 has ribs which extend longitudinally along the axis of the panel, and the apertures defined by the ribs have sides which are orientated at 45° to the axis of the panel. As a result, a substantially continuous screening aperture is deferred between adjacent ribs, which extends along the direction of flow of material to be screened along the panel. This results in a reduced screening efficiency of the known panel when compared to the panel of the invention, which present screening apertures which are substantially transverse to the flow of material over the panel, whilst simultaneously retaining the de-blinding properties associated with the flexible zig-zag shaped ribs.

Referring further to FIG. 1, as mentioned above, material to be screened may travel across the screening surface 12, either in the direction of arrow 40 axially along the panel, or in the direction of arrow 42 transversely across the panel, the material will depress a rib 14 over which it passes, before the material reaches an adjacent rib 14. By thus depressing the one rib 14 relative to the other, there is a slight difference in level between the ribs. The effect of this is that when the material reaches the following or subsequent rib, which is at a slightly higher level, and the edges of which define the sides 22.1 of the screening apertures 22, the rib 14 presents a slight ridge against which the material has to abut. This, particularly in view of the orientation of the sides 22.1 either transversely to the axis 10.1 of the panel in alignment with the axis of the panel, assists in forcing the material to drop into the screening apertures 22. Thereby the screening efficiency of the screening surface 12 is enhanced. This effect of forming a ridge against which the material to be screened has to abut is particularly enhanced by the chevron-like pattern in which the zig-zag ribs 14 are arranged within the periphery of the panel and across the screening surface 12. This effect is maintained even in the event of an oversize particle in the material being screened becoming temporarily wedged in a screening aperture.

This results in further advantages of the panel 10 of the invention compared with the panels of the Applicant's South African patent no. 88/8946. In the latter panels, the zig-zag shaped ribs are orientated parallel to the axis of the panel and in the direction of flow of material to be screened, along the panel. This results in the material being funnelled along between the ribs, and impinging to a large extent on those portions of the ribs where opposed ribs are closest to each other. This in turn causing excessive wear of the ribs at those points, and premature elongation or deformation of the screening apertures to approximate a slotted configuration. This decreases the screening accuracy of the known panels, and also decreases the effective life of the known panel. In the panels 10 of the invention, the orientation of the sides 22.1 of the screening apertures 22 substantially transversely to the axis of the panel, and also to the flow of material down the panel, means that the material being screened impinges mostly on the relatively sturdier and more wear-resistant sides 22.1 of the apertures 22, thus reducing the tendency of the apertures 22 to elongate or deform. Thereby a truer aperture size is maintained throughout the life of the panel 10. This maintains the screening efficiency of the panel 10, and thereby increases its effective life compared to the aforementioned known panels. This can be further enhanced by selection of an appropriate hard wearing material such as polyurethane or rubber from which the panels of the invention can be moulded, either by injection moulding or pressure moulding.

It is a still further advantage of the panel 10 according to the invention that, due to the orientation of the sides 22.1 of the apertures 22 substantially transversely to the flow of material down the panel, particles of material are generally not able to flow along the upper surfaces of the ribs and thereby pass over the panel, as is the case with the known panel of the Applicant's South African patent no. 88/8946.

A yet further advantage of the panel 10 of the Invention as shown in FIG. 1 of the drawings, is that, due to the sides 22.1 of the apertures 22 being substantially parallel to the sides 11 and 13 of the panel, and the sides 22.2 of the apertures 22 being substantially parallel to the sides 15 and 17 of the panel, more apertures 22 can be fitted into the screening surface 12, than is the case with the panel of the Applicant's South African Patent No. 88/8946. This in turn allows for a greater open area in the screening surface 12, and consequently greater screening efficiency.

Another advantage of the panel 10 of the invention is that the thickness of the ribs 14 can be increased such as to significantly Increase the effective life of the panel, without significantly sacrificing flexibility of the ribs. Also, in certain embodiments of the known panel of the Applicant's South African Patent No. 88/8946 and its foreign counterparts, the ribs are supported by supporting bridges which interconnect some of the ribs on the surface opposite to the screening surface, so as to prevent the screening apertures from enlarging in use and thereby having a reduced screening efficiency. The presence of these supporting bridges (not to be confused with the bridging pieces 24 of the panel 10 of the invention, which interconnect ribs 14 in some places on the screening surface of the panel 10) in the known panels reduces the open area of their screening surfaces, thereby reducing their screening efficiency. The absence of such supporting bridges in the panel of the invention therefore increases its screening efficiency when compared to the known panel.

The aforegoing advantages apply equally to the panel 100 of the invention as shown in FIG. 8 of the drawings.

Thus, the applicant believes that the combined effects of the reduction in blinding of the panel, as well as the enhanced screening accuracy and efficiency, due to the zig-zag configuration of the ribs and their spacing and positioning from each other to define between them rows of screening apertures which have some sides which are disposed transversely to the axis of the panel, and others which are aligned with the axis, provide a panel 10, 100 which is particularly advantageous and effective. The improved screening efficiency and longer effective life of the panel according to the invention results in a substantial saving in costs to the user, as the cost is calculated in terms of cost per ton of material screened.

1. A screening element which has a screening surface formed by a plurality of elongate ribs extending within the periphery across the element, the ribs either alternately changing direction or varying in width along their length and being resiliently deformable, the ribs being so orientated and spaced from each other to define between them rows of screening apertures, such that the screening apertures have at least some sides which are orientated substantially transversely to the axis of the screening elements.

2. A screening element as claimed in claim 1 wherein said sides of the screening apertures are orientated at an angle of from 65° to 125°, or from 245° to 305°, to the axis of the screening element.

3. A screening element as claimed in claim 1 or claim 2 wherein the ribs alternately change direction by being of zig-zag configuration.

4. A screening element as claimed in claim 3 wherein the zig-zag configuration of the ribs is angular so that substantially rectangular-shaped apertures are defined between the ribs, with opposed sides of the apertures being formed by edges of the ribs.

5. A screening element as claimed in claim 4 wherein a pair of opposed sides of each screening aperture is disposed substantially transversely to the axis of the screening element.

6. A screening element as claimed in claim 5 wherein the apertures are square.

7. A screening element as claimed in claim 1 or claim 2 wherein the ribs extend across the screening surface at an angle of from 10° to 80° or from 280° to 350° to the axis of the screening element.

8. A screening element as claimed in claim 7 wherein opposed portions of adjacent ribs are alternately spaced at different distances from each other, to thereby define between them the screening apertures.

9. A screening element as claimed in claim 8 which includes a centrally disposed, straight rib extending between axially opposed sides of the element; laterally opposed sides of the element interconnected and held in laterally spaced relationship by the axially opposed sides of the element, such that the element is divided into two rectangularly shaped portions, the ribs extending in a chevron-like fashion within the periphery of the element, one half of the chevron extending across each said portion and ending in the straight rib.

10. A screening element as claimed in claim 9 wherein the ribs forming one half of the chevron extend across the screening surface at an angle of from 10° to 80°, and the ribs forming the other half of the chevron extend across the screening surface at an angle of from 280° to 350°, to the axis of the screening element.

11. A screening element as claimed in claim 10 which is a panel having securing means adapted to secure the panel releasably in a side-by-side relationship with similar panels on a screen deck.

12. A screening element as claimed in claim 11 wherein the panel and the ribs and the securing means are of the same material and are unitary and in one piece.

13. A screening element as claimed in claim 12 wherein the securing means on the screening panel comprise a plurality of deformable spigot-like protrusions spaced from each other along the periphery of the panel.

14. A screening element as claimed in claim 13 wherein the protrusions are adapted to fit in pairs with the protrusions of an adjacent similar panel in complementary spaced apertures in a support structure of a screen deck.

15. A screening element as claimed in claim 14 wherein the protrusions are half-tubular so that when such protrusions are fitted in pairs in the apertures of the support structures the protrusions form tubular bores into which securing pins may be fitted to spread the protrusions to engage the support structure.

16. A screening element as claimed in claim 14 wherein the protrusions are solid.

17. A screening element as claimed in claim 1 which is reinforced by steel reinforcing bars embedded in the element.

18. A screening element as claimed in claim 1 wherein each rib tapers in the direction of the flow of material through the screening surface to thereby define screening apertures which diverge in the direction of flow of material through the apertures.

19. A screening element as claimed in claim 1 or claim 11 which is moulded by injection moulding of polyurethane or rubber.

20. A screen deck Including a support structure and one or more screening elements as claimed in claim 1 arranged on the support structure.
